(19) United States
(12) Patent Application Publication
(10) Pub. No.: US 2014/0071061 A1
(43) Pub. Date: Mar. 13, 2014

(54) METHOD FOR CONTROLLING EXECUTION OF CAMERA RELATED FUNCTIONS BY REFERRING TO GESTURE PATTERN AND RELATED COMPUTER-READABLE MEDIUM

(71) Applicants: Chih-Ping Lin, Hsinchu City (TW); Chung-Hung Tsai, Hsin-Chu Hsien (TW); Yu-Wei Wang, Hsinchu City (TW)

(72) Inventors: Chih-Ping Lin, Hsinchu City (TW); Chung-Hung Tsai, Hsin-Chu Hsien (TW); Yu-Wei Wang, Hsinchu City (TW)

(21) Appl. No.: 13/610,894

(22) Filed: Sep. 12, 2012

(51) Int. Cl. G06F 3/0488

(52) U.S. Cl. CPC G06F 3/0488
USPC 345/173

(57) ABSTRACT

A method for controlling execution of camera related functions includes at least the following steps: while a camera is active in a specific operational mode, receiving a user input which includes a gesture pattern; searching a target command mapping from a plurality of pre-defined command mappings according to the gesture pattern, wherein each of the pre-defined command mappings defines at least one pre-defined camera related function mapped to a pre-defined gesture pattern; and controlling execution of each camera related function defined by the target command mapping.

### BACKGROUND

The disclosed embodiments of the present invention relate to controlling an operation of a camera, and more particularly, to a method for controlling execution of camera related functions by referring to a gesture pattern and related computer-readable medium.

Due to the limitation of the display panel size of the portable electronic device (e.g., a mobile phone), the number of function icons allowed to be displayed on a display panel is restricted. Hence, when there are many different functions supported by the portable electronic device, a deeper menu tree is employed by the portable electronic device. It is not convenient for the user to find a desired menu option from such a deeper menu tree.

Camera systems may be built in a variety of portable electronic devices. For example, a smartphone is generally equipped with a built-in camera. With the development of the portable electronic device, the portable electronic device may support various camera functions. It is a trend for a portable electronic device to have an increasing number of camera functions implemented therein. Hence, due to the use of a deeper menu tree, the design of a user interface (UI) for operating the built-in camera would become more and more complicated.

Thus, there is a need for providing a portable electronic device with a more user friendly interface for a built-in camera system.

### SUMMARY

In accordance with exemplary embodiments of the present invention, a method for controlling execution of camera related functions by referring to a gesture pattern and related computer-readable medium are proposed to solve the above-mentioned problems.

According to a first aspect of the present invention, an exemplary method for controlling execution of camera related functions includes at least the following steps: while a camera is active in a specific operational mode, receiving a user input including a gesture pattern; searching a target command mapping from a plurality of pre-defined command mappings according to the gesture pattern, wherein each of the pre-defined command mappings defines at least one pre-defined camera related function mapped to a pre-defined gesture pattern; and controlling execution of each camera related function defined by the target command mapping.

According to a second aspect of the present invention, an exemplary computer-readable medium storing a program code for controlling execution of camera related functions is disclosed. The program code causes a processor to perform following steps when executed by the processor: while a camera is active in a specific operational mode, receiving a user input including a gesture pattern; searching a target command mapping from a plurality of pre-defined command mappings according to the gesture pattern, wherein each of the pre-defined command mappings defines at least one pre-defined camera related function mapped to a pre-defined gesture pattern; and controlling execution of each camera related function defined by the target command mapping.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart illustrating a method for controlling execution of camera related functions according to a first exemplary embodiment of the present invention.

FIG. 2 illustrates a list showing exemplary pre-defined camera related functions belonging to the “capture mode change” category.

FIG. 3 illustrates a list showing exemplary pre-defined camera related functions belonging to the “capture function selection” category.

FIG. 4 illustrates a list showing exemplary pre-defined camera related functions belonging to the “display effect function selection” category.

FIG. 5 illustrates a list showing exemplary pre-defined camera related functions belonging to the “switch mode” category.

FIG. 6 illustrates a list showing exemplary pre-defined camera related functions belonging to the “multi-function combine mode” category.

FIG. 7 is a diagram illustrating examples of certain pre-defined gesture patterns.

FIG. 8 is a diagram illustrating one exemplary capture mode change application in a camera preview mode.

FIG. 9 is a diagram illustrating an exemplary capture function selection application in a camera preview mode.

FIG. 10 is a diagram illustrating one exemplary 3D related application in a camera playback mode.

FIG. 11 is a diagram illustrating another exemplary 3D related application in a camera playback mode.

FIG. 12 is a diagram illustrating an exemplary image quality improvement application in a camera playback mode.

FIG. 13 is a diagram illustrating an exemplary switch mode application.

FIG. 14 is a diagram illustrating an exemplary multi-function combine application.

FIG. 15 is a diagram illustrating another exemplary multi-function combine application.

FIG. 16 is a diagram illustrating an exemplary personalized setting application.

FIG. 17 is a flowchart illustrating a method for controlling execution of camera related functions according to a second exemplary embodiment of the present invention.

FIG. 18 is a diagram illustrating one exemplary application for correcting the UI display result.

FIG. 19 is a diagram illustrating another exemplary application for correcting the UI display result.

FIG. 20 is a block diagram illustrating a portable electronic device according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is electrically connected to another device, that connection may be through a direct electrical connection, or through an indirect electrical connection via other devices and connections.

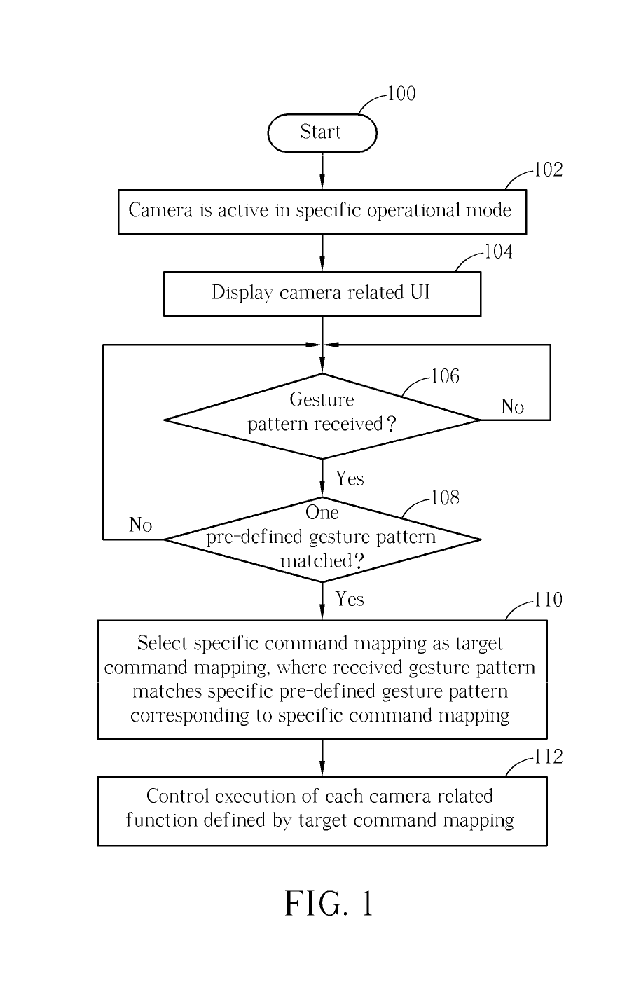

FIG. 1 is a flowchart illustrating a method for controlling execution of camera related functions according to a first exemplary embodiment of the present invention. If the result is substantially the same, the steps are not required to be executed in the exact order shown in FIG. 1. Besides, one or more of steps may be omitted and/or inserted, depending upon actual design/implementation consideration. The method may be briefly summarized by following steps.

Step 100: Start.

Step 102: A camera is active in a specific operational mode.

Step 104: Display a camera related user interface (UI).

Step 106: Check if a user input including a gesture pattern is received. If yes, go to step 108; otherwise, perform step 106 again to check the occurrence of a gesture pattern.

Step 108: Check if the received gesture pattern matches one of a plurality of pre-defined gesture patterns. If yes, go to step 110; otherwise, go to step 106 to check the occurrence of a next gesture pattern.

Step 110: Select a specific command mapping from a plurality of pre-defined command mappings as a target command mapping, where each of the pre-defined command mappings defines at least one pre-defined camera related function mapped to a pre-defined gesture pattern, and the received gesture pattern matches a specific pre-defined gesture pattern corresponding to the specific command mapping.

Step 112: controlling execution of each camera related function defined by the target command mapping.

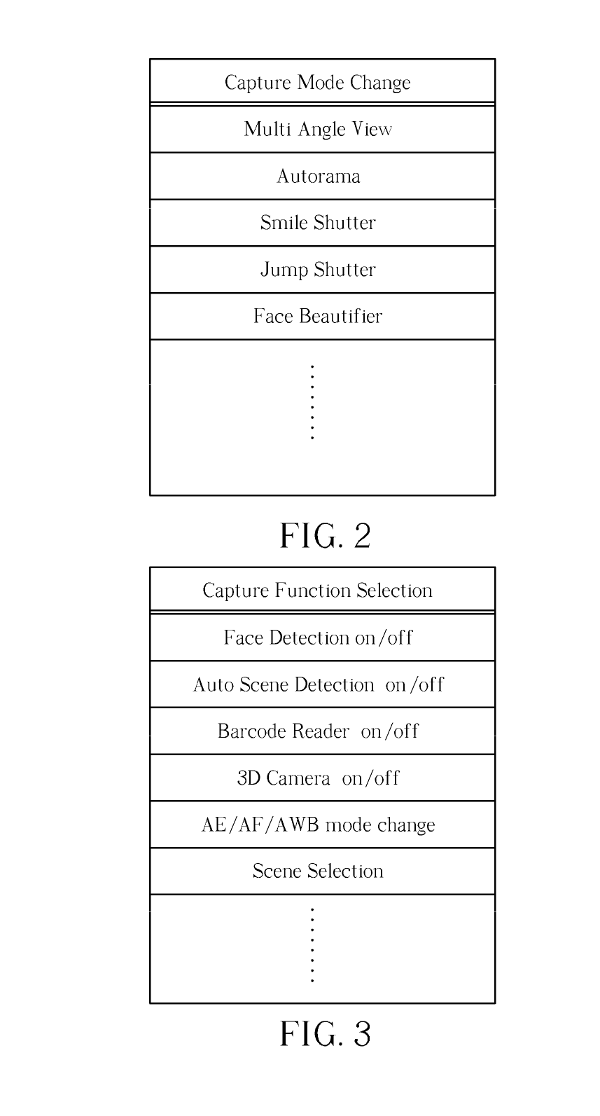

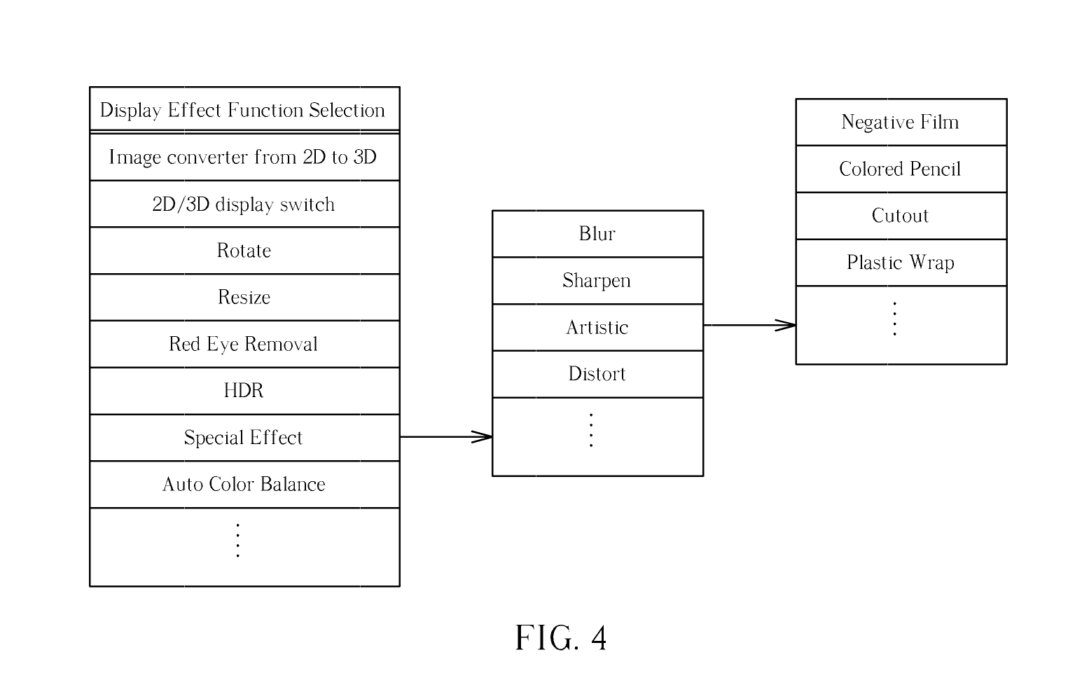

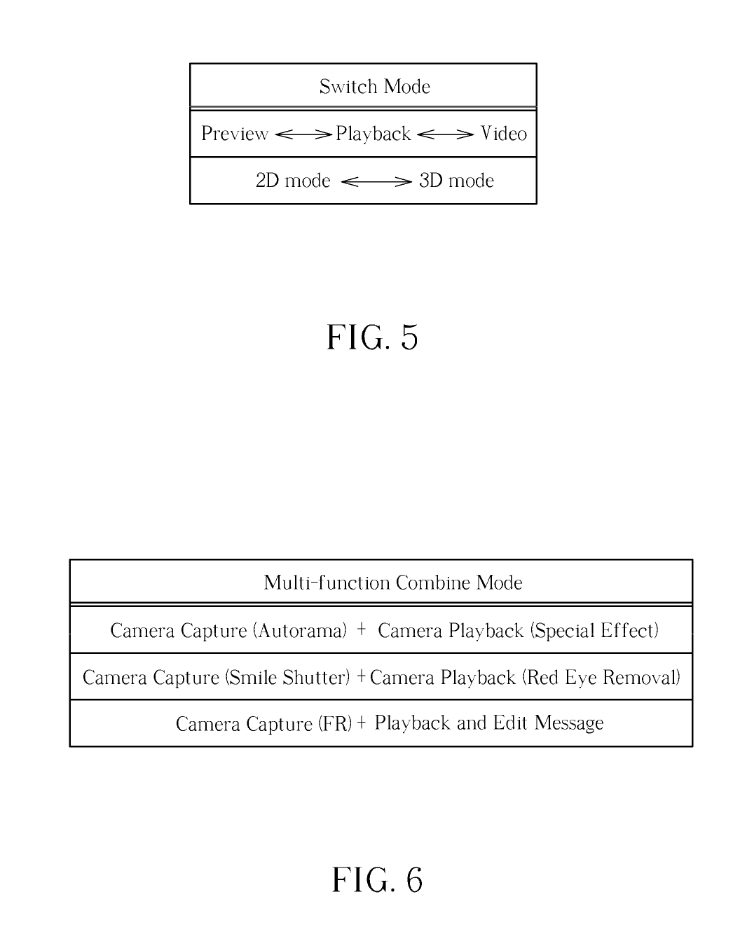

In the beginning, the user may operate a portable electronic device (e.g., a mobile phone) to enable a camera of the portable electronic device such that the camera is active in a specific operational mode (steps 100 and 102). By way of example, but not limitation, the specific operational mode may be a camera preview mode, a camera playback mode or other modes. When the camera operates in the camera preview mode, a camera related function may be configured to perform a capture mode change and/or a capture function selection. Please refer to FIG. 2 and FIG. 3. FIG. 2 illustrates a list showing exemplary pre-defined camera related functions belonging to the “capture mode change” category. “Autorama” in FIG. 2 means auto panorama, which allows user to press the shutter release button once instead of many times to capture images for generating panorama. FIG. 3 illustrates a list showing exemplary pre-defined camera related functions belonging to the “capture function selection” category. When the camera operates in the camera playback mode, a camera related function may be configured to perform a display effect function selection. Please refer to FIG. 4, which illustrates a list showing exemplary pre-defined camera related functions belonging to the “display effect function selection” category. When the camera operates in other mode (e.g., a switch mode, a multi-function combine mode, or a personalized setting mode), one or more camera related functions may be configured to perform a mode switching operation, execute multiple functions in order, or enable a personalized setting of the displayed camera related UI. Please refer to FIG. 5 and FIG. 6. FIG. 5 illustrates a list showing exemplary pre-defined camera related functions belonging to the “switch mode” category. FIG. 6 illustrates a list showing exemplary pre-defined camera related functions belonging to the “multi-function combine mode” category. It should be noted that the camera related functions shown in FIGS. 2-6 are for illustrative purposes only, and are not meant to be limitations of the present invention. That is, one or more camera related functions may be added to or removed from the lists shown in FIGS. 2-6 by the user.

While the camera of the portable electronic device is active in the specific operational mode, a display panel of the portable electronic device can show a camera related UI for the user (step 104). Therefore, the user is capable of knowing the current operational status of the camera through the displayed camera related UI. For example, the camera related UI can show a preview of an image to be captured in a camera preview mode, and show a captured image in a camera playback mode. It should be noted that step 104 may be optional. That is, even though the camera related UI is not displayed for informing the user of the current operational status of the camera, the user is still allowed to input a gesture pattern to the camera for enabling one or more desired camera related functions.

The occurrence of a gesture pattern can be detected in step 106. In one exemplary design, the gesture pattern is a finger gesture pattern received from a touch panel, where the camera and the touch panel may be disposed in the same portable electronic device. However, this is for illustrative purposes only, and is not meant to be a limitation of the present invention. That is, the gesture pattern may be obtained from any input unit which may receive user's gesture input, where the input unit may be external to or integrated within the portable electronic device in which the camera is disposed, the camera may be external to or integrated within the portable electronic device in which the input unit is disposed, or both the input unit and the camera are external to the portable electronic device.

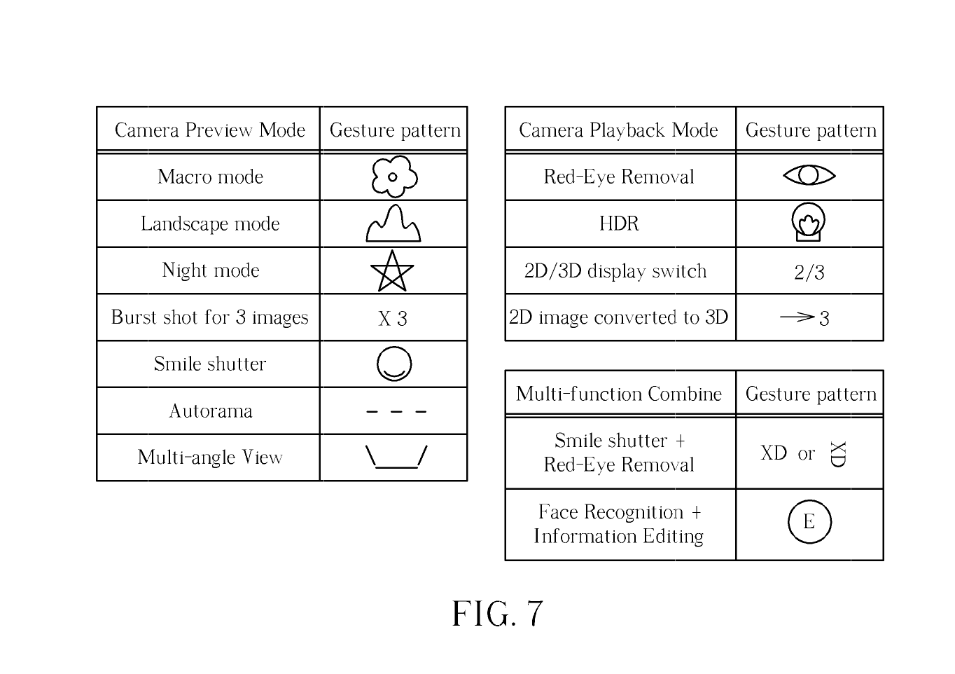

If it is determined that a gesture pattern of an user input is received, the flow can proceed with step 108 to check if the received gesture pattern matches one of a plurality of pre-defined gesture patterns. In other words, step 108 can be performed to check the validity of the received gesture pattern by referring to the pre-defined gesture patterns. Please refer to FIG. 7, which is a diagram illustrating examples of certain pre-defined gesture patterns. In this embodiment, different pre-defined gesture patterns are mapped to different camera related functions, respectively. That is, if a first camera related function is different from a second camera related function, a pre-defined gesture pattern assigned to the first camera related function is different from a pre-defined gesture pattern assigned to the second camera related function. However, this is for illustrative purposes only, and is not meant to be a limitation of the present invention. In an alternative design, a single pre-defined gesture pattern may be assigned to multiple camera related functions, such as different camera related functions belonging to different categories/scenarios. For example, a specific pre-defined gesture pattern may be mapped to a first camera related function belonging to the “Camera Preview Mode” category and a second camera related function belonging to the “Camera Playback Mode” category. When the user enters the specific pre-defined gesture pattern, the first camera related function is selected and executed if the camera is operating in the camera preview mode, and the second camera related function is selected and executed if the camera is operating in the camera playback mode,

When the received gesture pattern does not match any of the pre-defined gesture patterns, this implies that the received gesture pattern is not a valid gesture input. Hence, further processing associated with the received gesture pattern can be skipped, and the flow can proceed with step 106 to detect the occurrence of the next gesture pattern. When the received gesture pattern matches a specific pre-defined gesture pattern among the pre-defined gesture patterns, this implies that the received gesture pattern is a valid gesture input, and a specific command mapping corresponding to the specific pre-defined gesture pattern can be selected as a target command mapping found from a plurality of pre-defined command mappings (step 110).

Regarding the exemplary flow shown in FIG. 1, the flow can proceed with step 106 to detect the occurrence of the next gesture pattern when it is detected that the received gesture pattern is not a valid gesture input. In an alternative design, one or more additional steps may be inserted between step 108 and step 106. For example, after step 108 detects an invalid gesture input, an additional step can be executed to automatically display an editing UI or manually display the editing UI in response to a user input, thus allowing the user to edit (i.e., modify/add/remove) database of pre-defined gesture patterns and associated command mapping. Hence, after the database is properly updated, a gesture pattern previously recognized as an invalid gesture input can be recognized as a valid gesture input if the user enters the gesture pattern again.

Next, each camera related function defined by the target command mapping can be controlled to be executed (step 112). In a case where the target command mapping only defines a single camera related function mapped to the received gesture pattern, the single camera related function is executed accordingly. In another case where the target command mapping defines multiple camera related functions mapped to the received gesture pattern, these camera related functions can be executed in order. More specifically, the user is allowed to define a command mapping by combining more than one camera related function into a single pre-defined gesture pattern. Therefore, the user may input a single pre-defined gesture pattern in a multi-function combine mode to trigger a gesture command for executing more than one camera related function as a command queue.

In the following, several examples of inputting gesture patterns to activate desired camera related function(s) are provided for better understanding of technical features of the present invention.

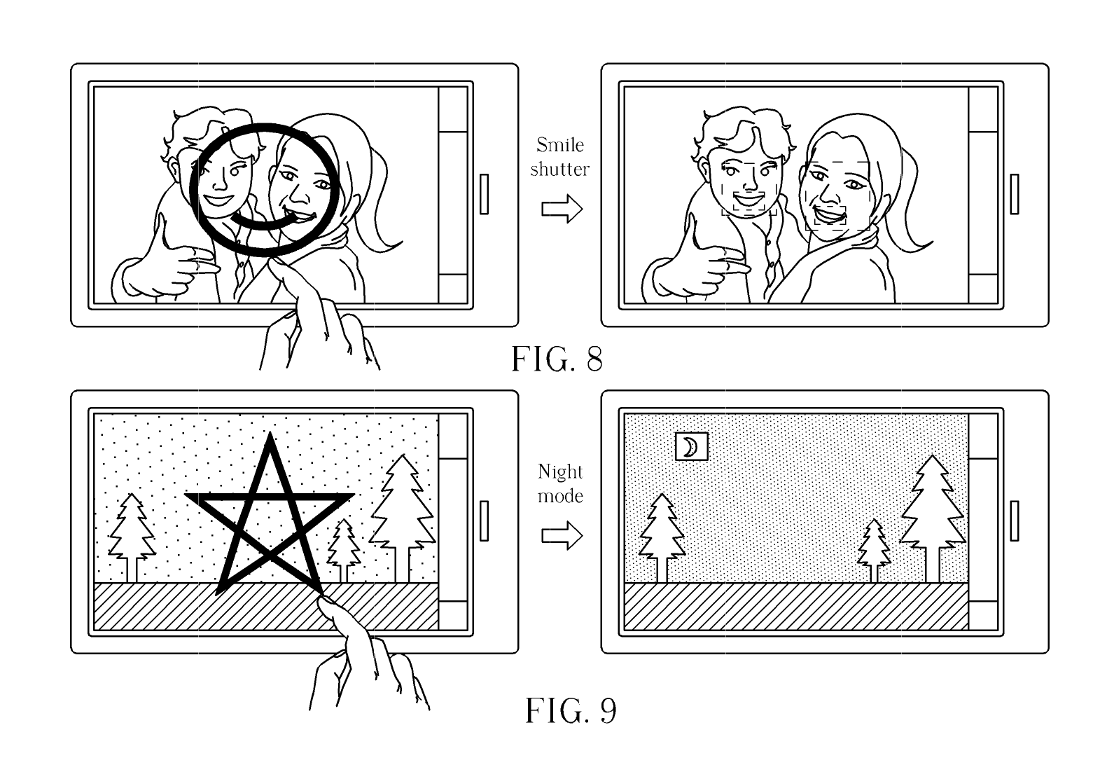

FIG. 8 is a diagram illustrating one exemplary capture mode change application in a camera preview mode. When the camera is operating in a camera preview mode and the user wants to change the current capture mode, the user may input a gesture pattern (e.g., a finger gesture pattern) on a touch panel. When user's gesture pattern matches a pre-defined gesture pattern which is mapped to a desired camera related function belong to the “capture mode change” category, the desired camera related function can be executed to adjust/change the current capture mode. As shown in FIG. 8, the user inputs the illustrated gesture pattern to make the capture mode changed from a normal mode to a smile shutter mode. In this embodiment, the smile shutter may be automatically enabled in response to user's gesture pattern without additional user intervention.

FIG. 9 is a diagram illustrating an exemplary capture function selection application in a camera preview mode. When the camera is operating in a camera preview mode and the user wants to enable a capture function, the user may input a gesture pattern (e.g., a finger gesture pattern) on a touch panel. When user's gesture pattern matches a pre-defined gesture pattern which is mapped to a desired camera related function belong to the “capture function selection” category, the desired camera related function can be executed to enable a capture function. As shown in FIG. 9, the user inputs the illustrated gesture pattern to make the scene mode set by a night mode. In this embodiment, the night mode may be automatically enabled in response to user's gesture pattern without additional user intervention.

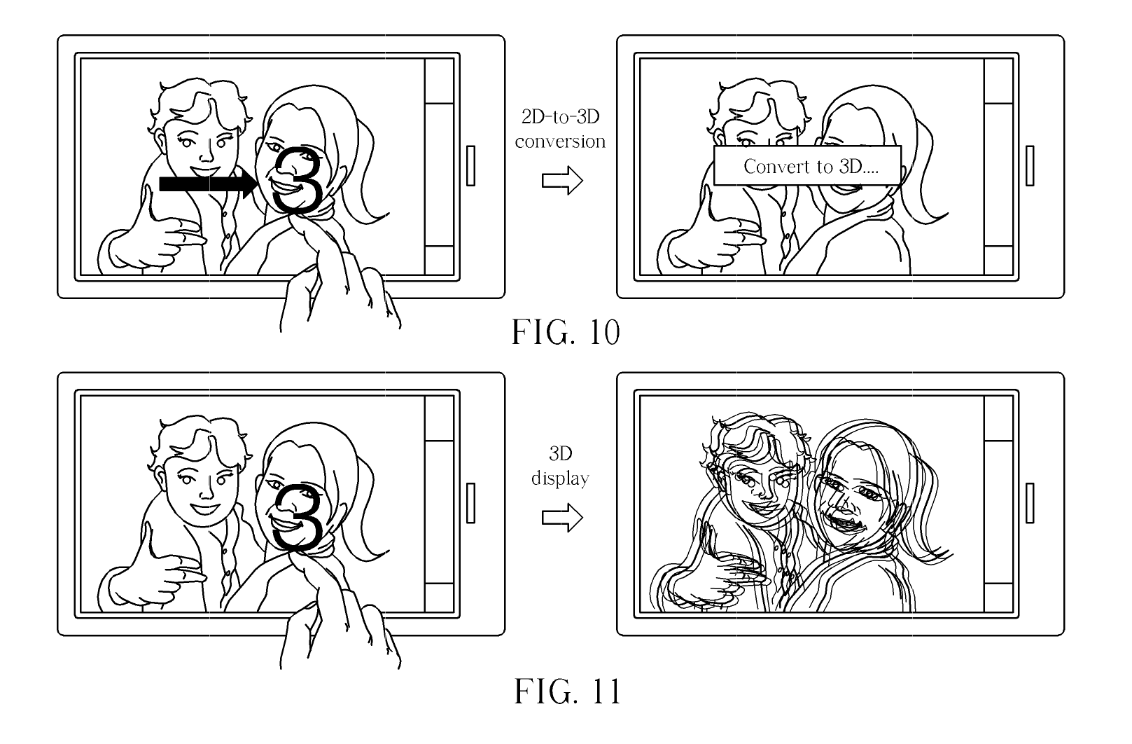

FIG. 10 is a diagram illustrating one exemplary 3D related application in a camera playback mode. When the camera is operating in a camera playback mode and the user wants to enable a playback function, the user may input a gesture pattern (e.g., a finger gesture pattern) on a touch panel. When user's gesture pattern matches a pre-defined gesture pattern which is mapped to a desired camera related function belong to the “display effect function selection” category, the desired camera related function can be executed to enable the playback function. As shown in FIG. 10, the user inputs the illustrated gesture pattern to make a 2D image converted into a 3D image. In this embodiment, the 2D-to-3D conversion may be automatically enabled in response to user's gesture pattern without additional user intervention.

FIG. 11 is a diagram illustrating another exemplary 3D related application in a camera playback mode. As shown in FIG. 11, the user may input the illustrated gesture pattern to switch the display panel from a 2D mode to a 3D mode. In this embodiment, a 3D image generated from a 2D image by using the aforementioned 2D-to-3D conversion or a 3D image obtained by any other methods may be automatically displayed in response to user's gesture pattern without additional user intervention.

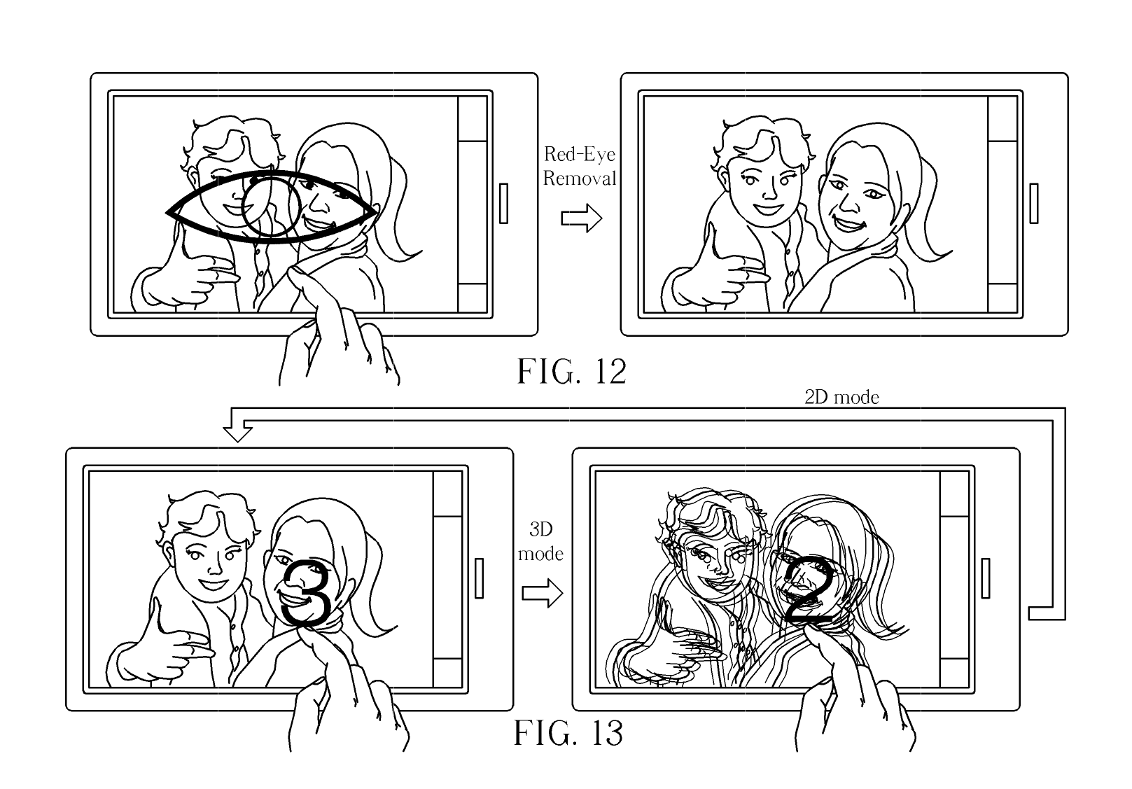

FIG. 12 is a diagram illustrating an exemplary image quality improvement application in a camera playback mode. When the camera is operating in a camera playback mode and the user wants to enable a playback function, the user may input a gesture pattern (e.g., a finger gesture pattern) on a touch panel. When user's gesture pattern matches a pre-defined gesture pattern which is mapped to a desired camera related function belong to the “display effect function selection” category, the desired camera related function can be executed to enable a playback function for image quality improvement. As shown in FIG. 12, the user may input the illustrated gesture pattern to enable the Red-eye removal. In this embodiment, the Red-eye removal may be automatically applied to the captured image in response to user's gesture pattern without additional user intervention.

FIG. 13 is a diagram illustrating an exemplary switch mode application. When the camera is operating in a specific operational mode and the user wants to switch between different modes, the user may input a gesture pattern (e.g., a finger gesture pattern) on a touch panel. When user's gesture pattern matches a pre-defined gesture pattern which is mapped to a desired camera related function belong to the “switch mode” category, the desired camera related function can be executed to enable the mode switching function. As shown in FIG. 13, the user may input one illustrated gesture pattern to switch a 2D mode to a 3D mode for displaying a 3D image under the camera playback mode. Besides, the user may input another illustrated gesture pattern to switch a 3D mode to a 2D mode for displaying a 2D image under the camera playback mode. In this embodiment, the switching between the 2D mode and the 3D mode may be automatically activated in response to user's gesture pattern without additional user intervention.

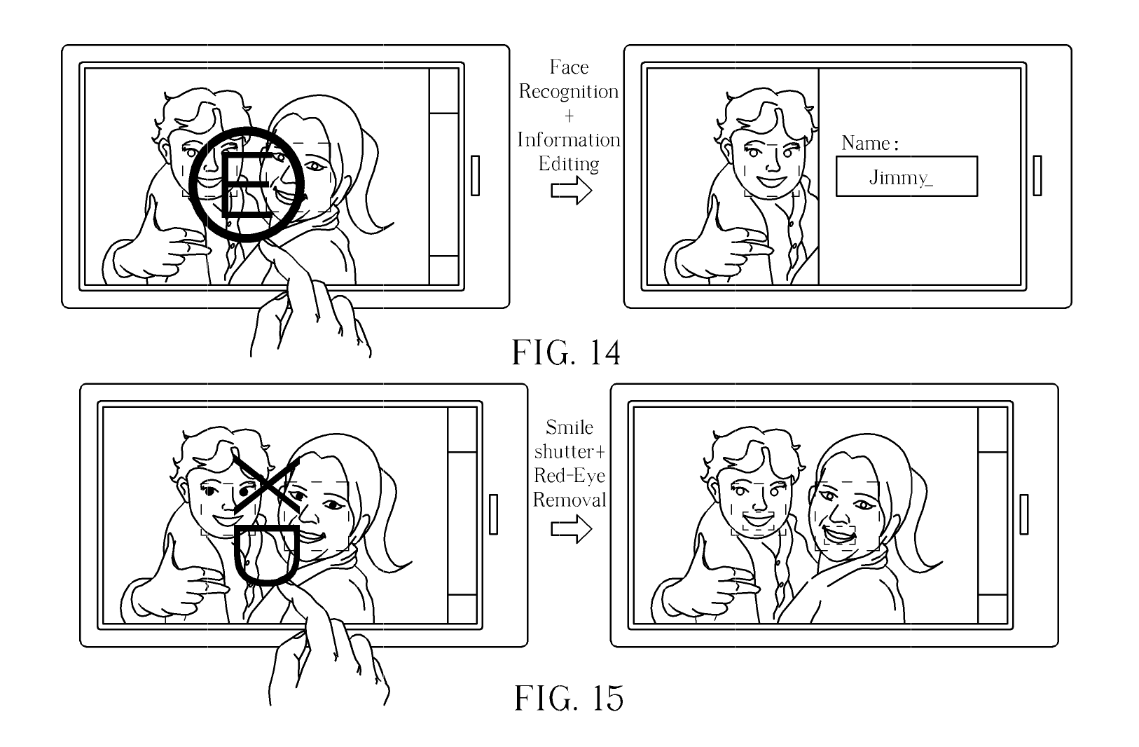

FIG. 14 is a diagram illustrating an exemplary multi-function combine application. When the camera is operating in a specific operational mode and the user wants to enable successive functions, the user may input a gesture pattern (e.g., a finger gesture pattern) on a touch panel. When user's gesture pattern matches a pre-defined gesture pattern which is mapped to a plurality of desired camera related functions belong to the “multi-function combine” category, the desired camera related functions can be executed in order. As shown in FIG. 14, the user may input one illustrated gesture pattern to enable face recognition function for capturing an image in the camera preview mode, and then enable an information editing function upon the captured image. In this embodiment, the face recognition function and the information editing function may be automatically activated in response to user's gesture pattern without additional user intervention.

FIG. 15 is a diagram illustrating another exemplary multi-function combine application. As shown in FIG. 15, the user may input one illustrated gesture pattern to enable smile shutter for capturing an image in the camera preview mode, and then enable Red-eye removal upon the captured image. In this embodiment, the smile shutter function and the Red-eye removal function may be automatically activated in response to user's gesture pattern without additional user intervention.

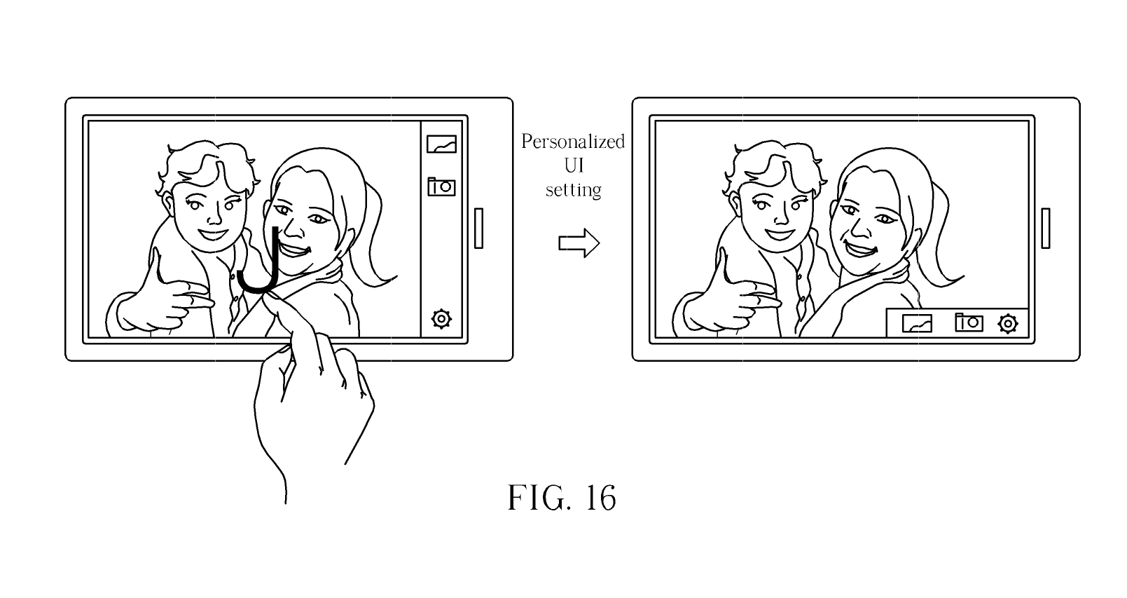

FIG. 16 is a diagram illustrating an exemplary personalized setting application. When the camera is operating in a specific operational mode and the user wants to have a preferred UI configuration on the portable electronic device, the user may input a gesture pattern (e.g., a finger gesture pattern) on a touch panel. When user's gesture pattern matches a pre-defined gesture pattern which is mapped to a desired camera related function for setting the camera related UI, the desired camera related function can be executed for allowing the user to perceive a preferred UI configuration on the portable electronic device. As shown in FIG. 16, the user may input the illustrated gesture pattern to make the current UI configuration changed to his/her preferred UI configuration. In this embodiment, the personalized setting may be automatically activated in response to user's gesture pattern without additional user intervention.

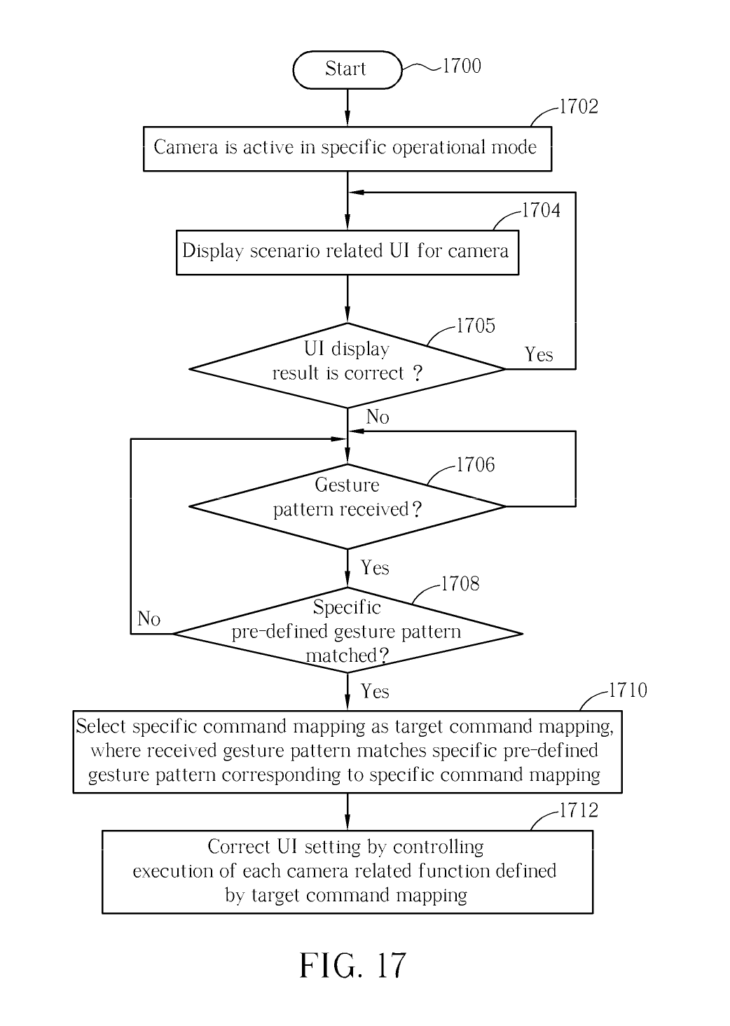

The proposed method of inputting gesture patterns to activate desired camera related function(s) may also be applied to all camera related scenarios. FIG. 17 is a flowchart illustrating a method for controlling execution of camera related functions according to a second exemplary embodiment of the present invention. If the result is substantially the same, the steps are not required to be executed in the exact order shown in FIG. 17. Besides, one or more steps may be omitted and/or inserted, depending upon actual design/implementation consideration. In this embodiment, the camera related function is used to correct a UI setting of the camera when a UI display result is found incorrect. The method may be briefly summarized by following steps.

Step 1700: Start.

Step 1702: A camera is active in a specific operational mode.

Step 1704: Display a scenario related user interface (UI) for the camera.

Step 1705: The user checks if a UI display result shown on a display panel is correct. If the UI display result is correct, go to step 1704; otherwise, go to step 1706.

Step 1706: Check if a user input including a gesture pattern is received. If yes, go to step 1708; otherwise, perform step 1706 again to check the occurrence of a gesture pattern.

Step 1708: Check if the received gesture pattern matches a specific pre-defined gesture pattern among a plurality of pre-defined gesture patterns. If yes, go to step 1710; otherwise, go to step 1706 to check the occurrence of a next gesture pattern.

Step 1710: Select a specific command mapping from a plurality of pre-defined command mappings as a target command mapping, where each of the pre-defined command mappings defines at least one pre-defined camera related function mapped to a pre-defined gesture pattern, and the received gesture pattern matches the specific pre-defined gesture pattern corresponding to the specific command mapping.

Step 1712: Correct the UI setting by controlling execution of each camera related function defined by the target command mapping.

When the user finds that the UI display result is different from a correct one, the user may input a gesture pattern (e.g., a finger gesture) to manually correct the UI setting. Step 1708 can be performed to check the validity of the gesture pattern received by step 1706. More specifically, the received gesture pattern can be regarded as a valid gesture pattern when the received gesture pattern matches a specific gesture pattern of the pre-defined gesture patterns, and the specific pre-defined gesture pattern corresponds to a pre-defined camera related function used for correcting the UI setting (e.g., a scene mode or an exposure value (EV)). When the valid gesture pattern is identified, step 1712 can be performed to correct the UI setting by controlling execution of each camera related function defined by a target command mapping which defines the specific pre-defined gesture pattern mapped to one or more pre-defined camera related functions. As a result, the display panel of the portable electronic device will have the correct UI display result shown thereon under the current camera related scenario. As a person skilled in the art may readily understand details of other steps after reading above paragraphs, further description is omitted here for brevity.

Regarding the exemplary flow shown in FIG. 17, the flow can proceed with step 1706 to detect the occurrence of the next gesture pattern when it is detected that the received gesture pattern is not a valid gesture input for correcting the UI setting. In an alternative design, one or more additional steps may be inserted between step 1708 and step 1706. For example, after step 1708 detects an invalid gesture input, an additional step can be executed to automatically display an editing UI or manually display the editing UI in response to a user input, thus allowing the user to edit (i.e., modify/add/remove) database of pre-defined gesture patterns and associated command mapping. Hence, after the database is properly updated, a gesture pattern previously recognized as an invalid gesture input can be recognized as a valid gesture input if the user enters the gesture pattern for correcting the UI setting again.

In the following, several examples of inputting gesture patterns to activate desired camera related function(s) for correcting the UI display results are provided for better understanding of technical features of the present invention.

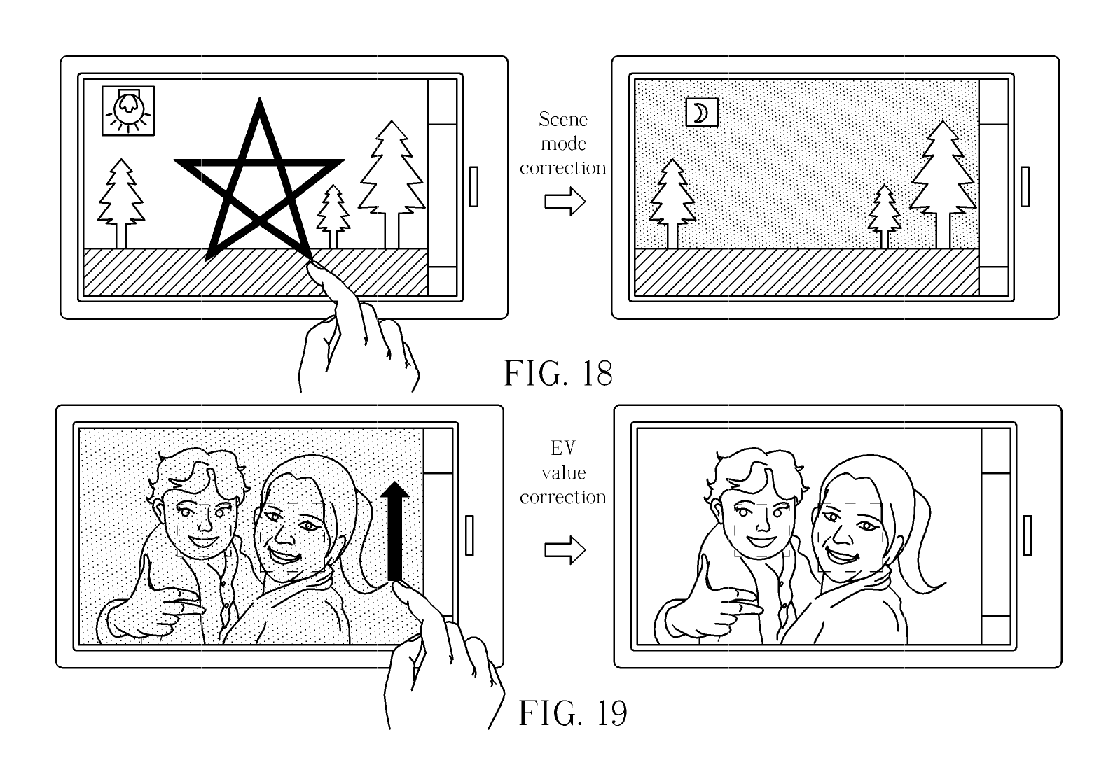

FIG. 18 is a diagram illustrating one exemplary application for correcting the UI display result. Suppose that the camera is operating in a camera preview mode and the auto scene detection (ASD) is enabled. When the user finds that the detection result of the ASD is incorrect, the user may input a gesture pattern (e.g., a finger gesture pattern) on a touch panel. When user's gesture pattern matches a pre-defined gesture pattern which is mapped to a desired camera related function for correcting the UI display result, the desired camera related function can be executed for allowing the user to perceive a correct UI display result on the display panel. As shown in FIG. 18, the user can input the illustrated gesture pattern to change the current scene mode from a backlight mode incorrectly detected by the ASD to a correct night mode. In this embodiment, the correction made to the ASD result can be automatically activated in response to user's gesture pattern without additional user intervention.

FIG. 19 is a diagram illustrating another exemplary application for correcting the UI display result. Suppose that the camera is operating in a camera preview mode and the auto exposure (AE) is enabled. When the user finds that the EV value is different from what he/she wants, he/she may input a gesture pattern (e.g., a finger gesture pattern) on a touch panel. When user's gesture pattern matches a pre-defined gesture pattern which is mapped to a desired camera related function for correcting the UI display result, the desired camera related function can be executed for allowing the preview image to have a desired EV value. As shown in FIG. 18, the user can input the illustrated gesture pattern to increase/decrease the EV value originally detected by the AE function. For example, an up arrow can be inputted to increase the EV value, while a down arrow can be inputted to decrease the EV value. In this embodiment, the correction made to the EV value can automatically activated in response to user's gesture pattern without additional user intervention.

Advantageously, the proposed method may only need user's one finger to input the gesture pattern, may be applied to all the camera related functions, may be applied to all camera related scenarios, may allow the user to edit (i.e., modify/add/remove) the command mappings, may combine more than one function into a single gesture pattern, and/or may reduce the UI menu tree to a single layer.

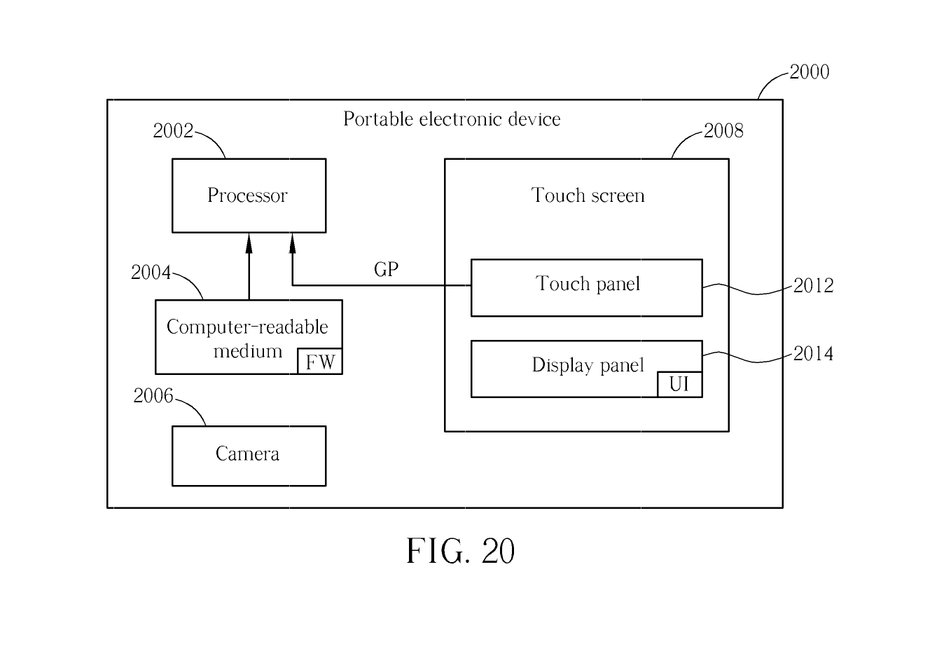

FIG. 20 is a block diagram illustrating a portable electronic device according to an embodiment of the present invention. The proposed method shown in FIG. 1/FIG. 17 may be employed by the portable electronic device 2000. As shown in FIG. 20, the portable electronic device 2000 may include a processor 2002, a non-transitory computer-readable medium 2004 (e.g., a non-volatile memory) coupled to the processor 2002, a camera 2006, and a touch screen 2008, where the touch screen 2008 may include a touch panel 2012 coupled to the processor 2002, and a display panel 2014. While the camera 2006 is active in a specific operational mode, the display panel 2014 may display a camera related UI correspondingly, and the touch panel 201 2 may generate a gesture pattern GP in response to a user input via the touch panel 2012. In this embodiment, the processor 2002 is capable of executing a program code (e.g., firmware FW of the portable electronic device 2000) to control execution of the camera related functions. In other words, the program code (e.g., firmware FW) may cause the processor 2002 to control execution of aforementioned steps when executed by the processor 2002.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for controlling execution of camera related functions, comprising:
while a camera is active in a specific operational mode, receiving a user input which includes a gesture pattern;
searching a target command mapping from a plurality of pre-defined command mappings according to the gesture pattern, wherein each of the pre-defined command mappings defines at least one pre-defined camera related function mapped to a pre-defined gesture pattern; and
controlling execution of each camera related function defined by the target command mapping.

2. The method of claim 1, wherein the gesture pattern is a finger gesture pattern, and the step of receiving the user input comprises:
receiving the finger gesture pattern from a touch panel.

3. The method of claim 1, wherein the step of searching the target command mapping comprises:
checking if the gesture pattern matches one of a plurality of pre-defined gesture patterns; and
when the gesture pattern matches a specific pre-defined gesture pattern corresponding to a specific command mapping, selecting the specific command mapping as the target command mapping.

4. The method of claim 1, wherein the step of controlling execution of each camera related function defined by the target command mapping comprises:
when the target command mapping is determined, controlling each camera related function defined by the target command mapping to be automatically executed without user intervention.

5. The method of claim 1, wherein the specific operational mode is a camera preview mode, and at least one camera related function defined in the target command mapping is for performing a capture mode change and/or a capture function selection.

6. The method of claim 1, wherein the specific operational mode is a camera playback mode, and at least one camera related function defined in the target command mapping is for performing a display effect function selection.

7. The method of claim 1, wherein at least one camera related function defined in the target command mapping is for switching the camera from the specific operational mode to a different operational mode.

8. The method of claim 1, wherein the target command mapping defines multiple camera related functions.

9. The method of claim 1, wherein at least one camera related function defined in the target command mapping is for enabling a personalized setting of a user interface (UI) of the camera.

10. The method of claim 1, wherein at least one camera related function defined in the target command mapping is for correcting a user interface (UI) setting of the camera when a UI display result is incorrect.

11. A non-transitory computer-readable medium, storing a program code for controlling execution of camera related functions, wherein the program code causes a processor to perform following steps when executed by the processor:
while a camera is active in a specific operational mode, receiving a user input which includes a gesture pattern;
searching a target command mapping from a plurality of pre-defined command mappings according to the gesture pattern, wherein each of the pre-defined command mappings defines at least one pre-defined camera related function mapped to a pre-defined gesture pattern; and
controlling execution of each camera related function defined by the target command mapping.

12. The non-transitory computer-readable medium of claim 11, wherein the gesture pattern is a finger gesture pattern, and the step of receiving the user input comprises:
receiving the finger gesture pattern from a touch panel.

13. The non-transitory computer-readable medium of claim 11, wherein the step of searching the target command mapping comprises:
checking if the gesture pattern matches one of a plurality of pre-defined gesture patterns; and
when the gesture pattern matches a specific pre-defined gesture pattern corresponding to a specific command mapping, selecting the specific command mapping as the target command mapping.

14. The non-transitory computer-readable medium of claim 11, wherein the step of controlling execution of each camera related function defined by the target command mapping comprises:
when the target command mapping is determined, controlling each camera related function defined by the target command mapping to be automatically executed without user intervention.

15. The non-transitory computer-readable medium of claim 11, wherein the specific operational mode is a camera preview mode, and at least one camera related function defined in the target command mapping is for performing a capture mode change and/or a capture function selection.

16. The non-transitory computer-readable medium of claim 11, wherein the specific operational mode is a camera playback mode, and at least one camera related function defined in the target command mapping is for performing a display effect function selection.

17. The non-transitory computer-readable medium of claim 11, wherein at least one camera related function defined in the target command mapping is for switching the camera from the specific operational mode to a different operational mode.

18. The non-transitory computer-readable medium of claim 11, wherein the target command mapping defines multiple camera related functions.

19. The non-transitory computer-readable medium of claim 11, wherein at least one camera related function defined in the target command mapping is for enabling a personalized setting of a user interface (UI) of the camera.

20. The non-transitory computer-readable medium of claim 11, wherein at least one camera related function defined in the target command mapping is for correcting a user interface (UI) setting of the camera when a UI display result is incorrect.
